(19) United States
(12) Patent Application Publication
(10) Pub. No.: US 2020/0289860 A1
(43) Pub. Date: Sep. 17, 2020

(54) Mask

(71) Applicant: HO TAN TRAN COMPANY LTD., Taichung City (TW)

(72) Inventor: Yen Jung Hu, Taichung City (TW)

(21) Appl. No.: 16/812,623

(22) Filed: Mar. 9, 2020

(30) Foreign Application Priority Data
Mar. 11, 2019 (TW) 108108103

(51) Int. Cl. A62B 23/02; A41D 13/11; B32B 5/26

(52) U.S. Cl. CPC A62B 23/025; A41D 13/11; B32B 2262/02; B32B 2307/726; B32B 5/26

(57) ABSTRACT

A novel mask comprises a mask body and two ear loop attachments attached on a left side and a right side of the mask body. The mask body comprises a filtration layer and two fibrous layers laminated together. The filtration layer comprises multiple fibers with diameter at a range of 50 to 800 nm. The fibrous layer comprises multiple fibers with diameter at a range of 0.5 μm to 8.0 μm. The diameters of the fibers of the fibrous layer are greater than the diameter of the fibers of the filtration layer. When using the present invention, two ear loop attachments are extended around ears of the wearer. The mask body hence covers the nose and the mouth of the wearer. As the wearer inhaling and exhaling air, the air will pass through the fibrous layers and filtration layer of the mask body. Particles or pollutions carried by the air will be blocked and retained by the fibrous layer.

### FIELD OF INVENTION

Present invention relates to a technical field of mask, especially to a novel mask with unique structure design for reducing pressure drop of air flow when air or breathe passing through the mask.

### BACKGROUND OF THE INVENTION

The conventional masks are normally utilized a filtration media with smaller pore sizes if a higher filtration efficiency function are resulted. This filtration media is able to block small particulate matters or pollutants in air for providing better air filtration effects for wearers or users.

Although this kind of mask with smaller pore sizes of filtration media could provide a better filtration effects, a smooth breathing of the air flow will also be affected when users wearing the mask. Especially to the high filtration efficiency media is made of or comprises the material called polytetrafluoroethylene (PTFE), the pressure drop of the filtration media made of PTFE between inhaling and exhaling could reach 35.7 mmH₂O or even 64.2 mmH₂O. Such high pressure drop will make uncomfortable feelings toward the users and even make the users hard to breathe. Not to mention that infant or children with lower or weaker breathing ability has a risk to be suffocated by this kind of mask.

Hence, it is eager to have a novel mask that will overcome or substantially ameliorate at least one or more of the deficiencies of a prior art, or to at least provide an alternative solution to the problems. It is to be understood that, if any prior art information is referred to herein, such reference does not constitute an admission that the information forms part of the common general knowledge in the art.

### SUMMARY OF THE INVENTION

In order to solve the shortcomings of the conventional high filtration efficiency mask with smaller pore sizes of filtration media could make uncomfortable feelings toward the users, the present invention is required.

The present invention provides a novel mask comprising a mask body and two ear loop attachments attached on a left side and a right side of the mask body, wherein: the mask body comprises a filtration layer and two fibrous layers laminated together. The filtration layer is sandwiched between two fibrous layers. One of the fibrous layer is a hydrophilic layer and the other one is a hydrophobic layer as a cover of the mask. The filtration layer comprises a ultra fine fibrous network-like structure media with its fiber diameter at a range of 50 to 800 nm(nanometer). The fibrous layer comprises multiple fibers structure media with its fiber diameter at a range of 0.5 μm(micrometer) to 8.0 μm. The diameter of the fibers of the fibrous layer is greater than the diameter of the fibers of the filtration layer.

As describing above, the present invention has advantages as following.

When using the present invention, two ear loop attachments are extended around ears of the wearer. The mask body hence covers the nose and the mouth of the wearer. As the wearer inhaling and exhaling air, the air will pass through the fibrous layers and the filtration layer of the mask body. Particles or pollutant pollutions carried by the air will be blocked and retained by the fibrous layer preventing the wearer from intake such particles or pollutant.

Since the diameter of the fiber of the fibrous layer is greater than the diameter of the fiber of the filtration layer, speed of the air flow will be slowed down when passing through the fibrous layer. The air flow pressure or air pressure drop will be decreased when the air passing through the filtration layer. This will prevent the problems like uncomfortable feelings or hard to breathe for the wearer.

Many of the attendant features and advantages of the present invention will become better understood with reference to the following detailed description considered in connection with the accompanying figures and drawings.

### BRIEF DESCRIPTION OF THE DRAWINGS

The steps and the technical means adopted by the present invention to achieve the above and other objects can be best understood by referring to the following detailed description of the preferred embodiments and the accompanying drawings.

FIG. 1 is a perspective view of a preferred embodiment in accordance to the present invention;

FIG. 2 is a breakdown view of the preferred embodiment in accordance to the present invention; and

FIG. 3 is another perspective view of a preferred embodiment in accordance to the present invention.

### DETAILED DESCRIPTION OF THE PREFERRED EMBODIMENTS

In order to make purposes, technical solutions, and advantages of the present invention to be clearer, the following content provides some preferred embodiments in accordance to the present invention.

Reference will now be made in detail to the present preferred embodiments of the invention, examples of which are illustrated in the accompanying drawings. Wherever possible, the same reference numbers are used in the drawings and the description to refer to the same or like parts. It is not intended to limit the method by the exemplary embodiments described herein. In the following detailed description, for purposes of explanation, numerous specific details are set forth in order to attain a thorough understanding of the disclosed embodiments. It will be apparent, however, that one or more embodiments may be practiced without these specific details. As used in the description herein and throughout the claims that follow, the meaning of “a”, “an”, and “the” may include reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean “including but not limited to”.

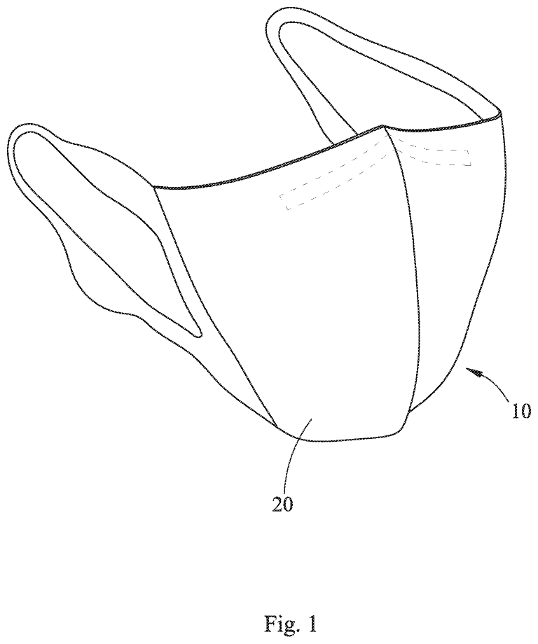

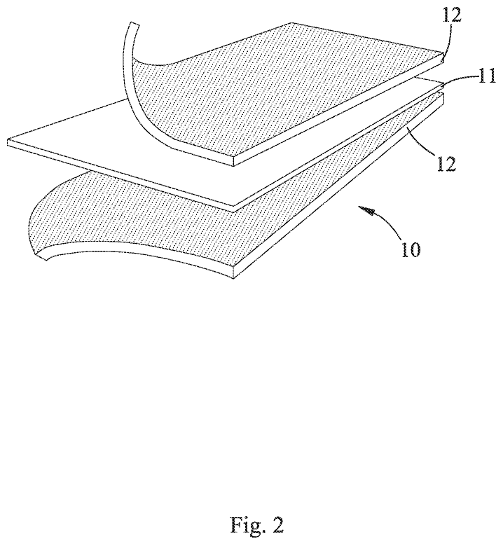

With reference to FIGS. 1 and 2, a preferred embodiment of a novel mask of the present invention comprises a mask body 10 for covering at least nose and mouth of a wearer. Two ear loop attachments 20 are attached on a left side and a right side of the mask body 10 respectively.

The mask body 10 comprises a filtration layer 11. The filtration layer 11 is a fibrous film or membrane made of or comprises polytetrafluoroethylene (PTFE), polyvinylidine chloride (PVDC), polyethylene (PE), polypropylene (PP) or electrostatic spun fiber web. In this preferred embodiment, the filtration layer 11 comprises PTFE fibrous film. Diameter of each fiber of the PTFE fibrous film is at a range of 50 nanometer (nm) to 800 nm.

Two fibrous layers 12 are laminated and attached to each side of the filtration layer 11. One of the fibrous layer 12 is a hydrophilic nonwoven fabric and the other is a hydrophobic nonwoven fabric. In this preferred embodiment, the hydrophilic nonwoven fabric is located inside which is closed or attached to the face of the wearer and the hydrophobic nonwoven fabric is located outside. The fibrous layer 12 is preferably a meltblown non-woven fabric comprises polypropylene (PP), polybutylene terephthalate (PBT) or polyamide (PA) fiber. The fiber of the fibrous layer 12 is preferred to be an ultra fine fiber with extreme thin diameter, also known as ultra fine fiber nonwoven fabric. In this preferred embodiment, the fibrous layer 12 is PP meltblown non-woven fabric with 15 gsm (g/m²) specification. Diameter of the fiber of the fibrous layer 12 is at a range of 0.5 micrometer (μm) to 3.0 μm. However, the diameter of the fiber of each fibrous layer 12 is greater than the diameter of the fiber of the filtration layer 11 in the present invention.

The ear loop attachments 20 are loop shaped strip or film extending from left and right side edges of the mask body 10. More preferably, the ear look attachments 20 are integrated with the mask body 10.

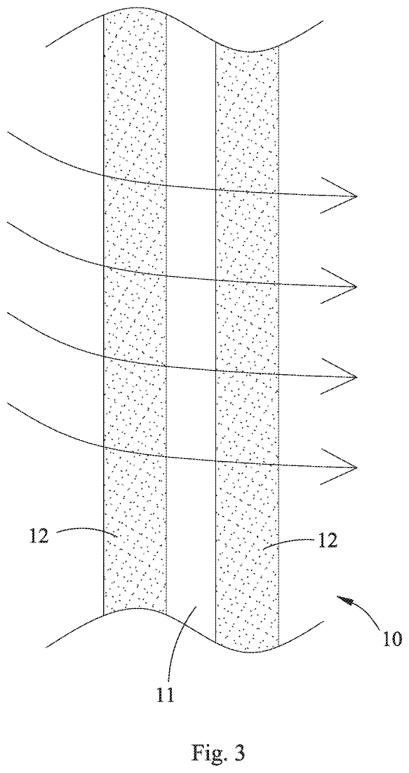

When using the present invention, two ear loop attachments 20 are extended around ears of the wearer. The mask body 10 hence covers the nose and the mouth of the wearer. As the wearer inhaling and exhaling air, the air will pass through the fibrous layers 12 and filtration layer 11 of the mask body 10. With reference to FIG. 3, particles or pollutions carried by the air will be blocked and retained by the fibrous layer 12. Since the diameter of the fiber of the fibrous layer 12 is greater than the diameter of the fiber of the filtration layer 11, speed of the air flow will be slowed down when passing through the fibrous layer 12. Hence, the air flow pressure or air pressure drop will be decreased when the air passing through the filtration layer 11. This will prevent the problems like uncomfortable feelings or hard to breathe for the wearer.

A test standard of CNS 14755 Z2125 is followed in the present invention. The testing NaCl particles size is 0.075 μm and air flow rate is 85.1 Liter/min. After testing, the actual air flow pressures or air pressure drops of inhaling and exhaling of the present invention are decreased from 35.7 mmH₂O to 25.1 mmH₂O (inhaling) and 64.2 mmH₂O to 39.2 mmH₂O (exhaling). Thus, the filtration efficiency of the composed filtration layer/media 11 of the mask body 10 while inhaling and exhaling are 98.67% and 99.78%. Since the air flow pressures or air pressure drops are actually decreased, the wearer could be guaranteed with more comfortable feelings when wearing the mask provided by the present invention.

A second embodiment of the present invention is to have only one fibrous layer 12 layered with the filtration layer 11. This only one fibrous layer 12 could be layered at any side of the filtration layer 11 and achieved similar effect to the present invention. In this embodiment with only one fibrous layer 12 layered with the filtration layer 11, the actual air flow pressures or air pressure drops of inhaling and exhaling are decreased from 35.7 mmH₂O to 20.9 mmH₂O (inhaling) and 64.2 mmH₂O to 54 mmH₂O (exhaling). The filtration efficiency of the mask body 10 while inhaling and exhaling are 96.5% and 99.92%. This embodiment also achieve the propose of decreasing air flow pressures or air pressure drops for the mask body 10 and provide more comfortable feelings for the wearer when wearing the mask of the present invention.

Moreover, the diameter of the fiber of the fibrous layer 12 could also at a range of 0.5 μm to 80 μm as long as its diameter is greater than the diameter of the fiber of the filtration layer 11 for achieving the effect of decreasing air flow pressures or air pressure drops for the mask body 10.

The above specification, examples, and data provide a complete description of the present disclosure and use of exemplary embodiments. Although various embodiments of the present disclosure have been described above with a certain degree of particularity, or with reference to one or more individual embodiments, those with ordinary skill in the art could make numerous alterations or modifications to the disclosed embodiments without departing from the spirit or scope of this disclosure.

What is claimed is:

1. A novel mask comprising a mask body and two ear loop attachments attached on a left side and a right side of the mask body, wherein:
the mask body comprises a filtration layer and two fibrous layers laminated together;
the filtration layer is sandwiched between two fibrous layers; one of the fibrous layer is a hydrophilic layer and the other one is a hydrophobic layer as a cover of the mask;
the filtration layer comprises multiple fibers with diameter at a range of 50 to 800 nm(nanometer);
each fibrous layer comprises multiple fibers with diameter at a range of 0.5 μm to 8.0 μm; and
the diameter of the fibers of the fibrous layer are greater than the diameter of the fibers of the filtration layer.

2. The novel mask as claimed in claim 1, wherein: the fibrous layer is made of or comprises polypropylene meltblown non-woven fabric, polybutylene terephthalate meltblown non-woven fabric, ultra fine fiber nonwoven fabric or polyamide meltblown non-woven fabric.

3. The novel mask as claimed in claim 1, wherein: the filtration layer is a fibrous film or membrane made of or comprises polytetrafluoroethylene, polyvinylidine chloride, polyethylene, polypropylene or electrostatic spun fiber.

4. The novel mask as claimed in claim 2, wherein: the fibrous layer is a fibrous film or membrane comprises polytetrafluoroethylene, polyvinylidine chloride, polyethylene, polypropylene or electrostatic spun fiber.
